(19) United States
(12) Patent Application Publication
(10) Pub. No.: US 2017/0330177 A1
(43) Pub. Date: Nov. 16, 2017

(54) PAYMENT TERMINAL AUTHENTICATION

(71) Applicant: Hewlett Packard Enterprise Development LP, Houston, TX (US)

(72) Inventors: Branislav Meandzija, Sunnyvale, CA (US); Terence Spies, Cupertino, CA (US)

(21) Appl. No.: 15/155,279

(22) Filed: May 16, 2016

(51) Int. Cl. G06Q 20/38; G06Q 20/20

(52) U.S. Cl. CPC G06Q 20/388; G06Q 20/3829; G06Q 20/202; G06Q 2220/00

(57) ABSTRACT

Examples relate to transaction authentication. In one example, a computing device may: receive, from a payment terminal: transaction data for a transaction, a terminal identifier of the payment terminal, and a first message authentication code (MAC) for the transaction; obtain, from an authentication cache and using the terminal identifier, a terminal secret for the payment terminal; combine the transaction data and the terminal identifier to create a message; generate a second message authentication code (MAC) using the message as input and the terminal secret as a key; and determine, using the first MAC and second MAC, whether the transaction data is authentic.

### BACKGROUND

Consumers and merchants often make use of payment systems to process a variety of transactions. For example, credit card purchases are often initiated using a payment terminal to facilitate the transfer of transaction information to various parties, such as a payments processor, issuing bank, and receiving bank. Transaction information may often include sensitive information, such as an account number, that should be protected from improper use.

### BRIEF DESCRIPTION OF THE DRAWINGS

The following detailed description references the drawings, wherein:

FIG. 1 is a block diagram of an example computing device for payment terminal authentication.

FIG. 2 is a data flow depicting payment terminal authentication.

FIG. 3 is a flowchart of an example method for payment terminal authentication.

FIG. 4 is a flowchart of an example method for payment terminal authentication at a host device.

### DETAILED DESCRIPTION

Payment terminal authentication allows a host device, such as a payments processor, to determine that a particular payment terminal originated a given transaction and that the transaction's integrity has not been compromised. The payment terminal generates its own authentication credentials and communicates them to the host device to enroll in terminal authentication. The terminal's authentication credentials may be changed, allowing a payment terminal to be safely re-deployed and re-enrolled. The host device has options for handling terminal enrollment that allow the host to determine how to handle new enrollments and payment terminal changes.

By way of example, a merchant may deploy a new payment terminal in a retail store for processing credit card transactions. To enroll the payment terminal at a host payment gateway of the merchant, the payment terminal may generate a pseudo-random terminal secret, which may be encrypted with a terminal identifier and transmitted to a host device, e.g., using Identity-Based Key Encapsulation and Encryption Protocol (IBKEEP) or another terminal transmission protocol. The host device records the terminal identifier and secret in an authentication cache when enrolling the new terminal and, in some implementations, may also associate the terminal with a point of sale (POS) identifier that identifies a POS for the new terminal.

To handle a transaction, e.g., a credit card transaction, the terminal combines encrypted transaction data—such as the credit card number, purchaser's name, transaction amount, etc.—with the terminal identifier to create a message. The message is then provided to a message authentication code (MAC) algorithm to produce a MAC, e.g., by hashing the message. The MAC algorithm is keyed, or seeded, with the terminal's secret. The MAC, terminal identifier, and encrypted transaction data are provided to the host device for authentication. The host device uses the terminal identifier to find the terminal's secret in its authentication cache. The host device creates a second message by combining the encrypted transaction data provided by the terminal with the terminal identifier and provides that second message to the MAC algorithm using the terminal secret as a key. This produces a second MAC, which may be compared to the first MAC to determine whether the transaction data has been modified.

The host device may determine, based on the first and second MAC matching, that the transaction came from the particular terminal—the terminal enrolled and associated with the terminal identifier—and that the transaction data was not changed after it was hashed. A payment processing center may use multiple hosts to handle payment terminal authentication in a distributed manner. Hosts may be configured to handle enrollment and authentication messages in a variety of ways, including the ability to handle payment terminal re-deployment and changes in terminal credentials. As noted above, payment terminals may change their credentials, e.g., in response to a potential compromise or re-deployment, and be able to authenticate with a host device using new credentials. Further details and examples for payment terminal authentication are provided in the paragraphs that follow.

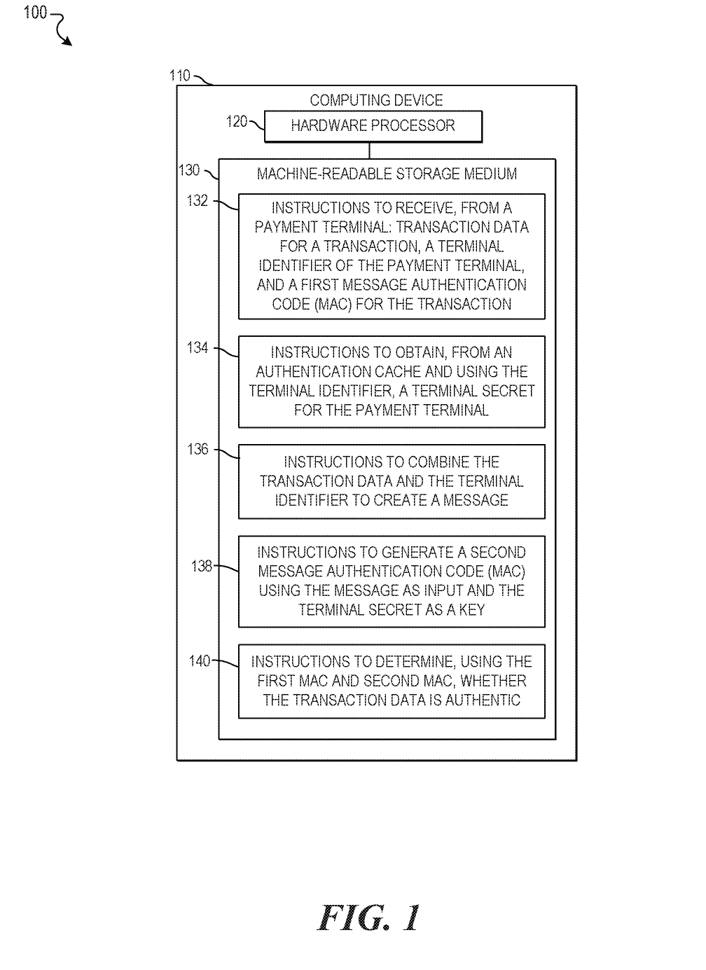

Referring now to the drawings, FIG. 1 is a block diagram 100 of an example computing device 110 for payment terminal authentication. Computing device 110 may be, for example, a personal computer, a server computer, mobile computing device, or any other similar electronic device capable of processing data and communicating with a payment terminal. In the example implementation of FIG. 1, the computing device 110 includes a hardware processor, 120, and machine-readable storage medium, 130.

Hardware processor 120 may be one or more central processing units (CPUs), semiconductor-based microprocessors, and/or other hardware devices suitable for retrieval and execution of instructions stored in machine-readable storage medium, 130. Hardware processor 120 may fetch, decode, and execute instructions, such as 132-140, to control processes for payment terminal authentication. As an alternative or in addition to retrieving and executing instructions, hardware processor 120 may include one or more electronic circuits that include electronic components for performing the functionality of one or more instructions, e.g., a Field Programmable Gate Array (FPGA) or Application Specific Integrated Circuit (ASIC).

A machine-readable storage medium, such as 130, may be any electronic, magnetic, optical, or other physical storage device that contains or stores executable instructions. Thus, machine-readable storage medium 130 may be, for example, Random Access Memory (RAM), non-volatile random access memory (NVRAM), an Electrically Erasable Programmable Read-Only Memory (EEPROM), a storage device, an optical disc, and the like. In some implementations, storage medium 130 may be a non-transitory storage medium, where the term “non-transitory” does not encompass transitory propagating signals. As described in detail below, machine-readable storage medium 130 may be encoded with executable instructions: 132-140, for payment terminal authentication.

As shown in FIG. 1, the hardware processor 120 executes instructions 132 to receive, from a payment terminal: transaction data for a transaction, a terminal identifier of the payment terminal, and a first message authentication code (MAC) for the transaction. The aforementioned data may be transmitted to the computing device 110 in an application message, e.g., a portion or all of the data may be transmitted inside an encryption transmission block (ETB) included in an application message from the payment terminal to the computing device 110.

By way of example, a payment terminal deployed at a merchant's retail store may receive transaction data in the form of a consumer's credit card data and other information related to the purchase. The payment terminal may obtain some transaction data, such as the credit card holder's account number and name, from the consumer's credit card, while some information may be obtained from a point-of-sale (POS) device associated with the payment terminal, e.g., a cashier's computer. In some implementations, the payment terminal and POS may be included in a single device. After receiving the transaction data, the payment terminal may send that transaction data, along with a terminal identifier and a MAC, to a host device that performs terminal verification, such as the computing device 110. Further details regarding the terminal identifier and MAC are described below.

In some implementations, various portions of the data transmitted between the payment terminal and computing device 110 may be encrypted in a variety of ways. In one example situation, the transaction data provided by the payment terminal is encrypted using a random AES key. The key used to decrypt the transaction data may also be included in the data sent from the payment terminal to the computing device 110. For example, the random AES key used to encrypt the transaction data may be encrypted using a public key associated with the computing device 110. E.g., the payment terminal may generate a random AES key and, using identity based encryption, use the host device's identity to generate the public key for the host device. The payment terminal then uses the host's public key to encrypt the random AES key before it is transmitted to the host device. Using identity-based encryption, the host device may then decrypt the random AES key using its private key. The host device may then use the random AES key to decrypt the transaction data.

In some implementations, the computing device 110 receives a point-of-sale (POS) identifier for a POS associated with the payment terminal. A POS may be used to facilitate processing transactions with one or more payment terminals, e.g., by providing communications channels and transaction data. A POS may have multiple payment terminals or a single payment terminal. The POS identifier may be sent separately or included in the same message that includes the transaction data, terminal identifier, and MAC. In some implementations, the POS associated with the payment terminal provides the POS identifier, e.g., by adding it to the message or sending it separately to the computing device 110.

The hardware processor 120 executes instructions 134 to obtain, from an authentication cache and using the terminal identifier, a terminal secret for the payment terminal. An authentication cache is used by the computing device 110 to store data used to authenticate payment terminals that have enrolled with the computing device 110. Each payment terminal enrolled with the computing device 110 previously provided the computing device 110 with that terminal's secret and the terminal's identifier. A POS identifier may, in some implementations, have also been provided to the computing device 110 during enrollment. By way of example, the host device may use the terminal identifier received with the transaction data to find, in the authentication cache, the terminal secret and POS identifier that were associated with the terminal identifier when the payment terminal enrolled.

The hardware processor 120 executes instructions 136 to combine the transaction data and the terminal identifier to create a message. For example, the host device may concatenate the transaction data and terminal identifier to form the message. In implementations where data is encrypted, encrypted strings may be used to form the message. For example, in situations where the transaction data is encrypted using a random AES key, the message may be created by concatenating the encrypted transaction data string with the plain text terminal identifier.

The hardware processor 120 executes instructions 138 to generate a second MAC using the message as input and the terminal secret as a key. For example, the host device may provide the message as input to a keyed hash function that uses the terminal secret as a key to hash the message, producing the second MAC. The first MAC that was received from the payment terminal was generated in a similar manner using the same MAC function as the host device. A variety of MAC algorithms may be used, such as CMAC, HMAC, UMAC, VMAC, or block cipher MAC algorithms such as OMAC, PMAC, and CBC-MAC.

The hardware processor 120 executes instructions 140 to determine, using the first MAC and second MAC, whether the transaction data is authentic. Data integrity and authenticity may be determined, for example, by comparing the first and second MACs to determine whether they match. In situations where the MACs match, the host device uses the match to determine that the transaction data is authentic, that it has not been changed, and that the payment terminal has been verified as enrolled. In situations where the MACs do not match, the host device may determine that the integrity of the transaction data and/or payment terminal has been compromised.

In implementations where a POS identifier is included in the data provided to the computing device 110, the POS identifier may be used to determine whether the payment terminal is enrolled with a POS identified by the received POS identifier. By way of example, during enrollment for a particular payment terminal with a host device, a triple that includes the POS identifier, terminal identifier, and terminal secret of the payment terminal may be saved in the host device's authentication cache. The host device may use the terminal identifier included with transaction data to obtain, from the triple, the POS identifier recorded for the payment terminal that provided the transaction data. If the POS identifier obtained from the authentication cache does not match the POS identifier provided with the transaction data, this indicates that the POS has changed. This may occur, for example, due to the merchant moving the payment terminal to a different POS and/or due to mislabeling of the message. Matching POS identifiers indicates that the payment terminal was enrolled with the same POS that it is currently using.

The computing device 110 may, in some implementations, allow already enrolled payment terminals to change their corresponding identifiers and secrets. For example, subsequent to determining that transaction data received from a payment terminal is authentic, the hardware processor 120 may execute instructions to receive encrypted enrollment data from the payment terminal. The encrypted enrollment data may include a new terminal identifier and/or a new terminal secret for the payment terminal. Upon receipt of the encrypted enrollment data, the hardware processor 120 may execute instructions to update the authentication cache with the new terminal identifier and/or the new terminal secret. A payment terminal may change their identifier and/or secret for a variety of reasons. For example, if a payment terminal or transaction sent from a payment terminal is compromised in some way, the payment terminal may change its secret and/or identifier to prevent further compromise. As another example, a merchant may wish to re-deploy a payment terminal at a different retail location or may transfer the payment terminal to a new merchant. In either of these situations, the merchant may want to re-enroll the payment terminals, e.g., by updating the identifier and/or secret.

While the example computing device 110 of FIG. 1 is discussed in the context of a single computing device 110 with a single authentication cache, in some implementations, multiple computing devices may be operate in a distributed manner to handle payment terminal enrollments and transactions. For example, multiple host devices may reside at a merchant's payment processing center, and the particular host device that handles any given communication from a payment terminal may not be predetermined. Each host device may have its own authentication cache for handling enrollments and transactions at that host device. In some implementations, terminal enrollment records may be shared between distributed host devices, and in some implementations a centralized database may be used for storing payment terminal records. In implementations where multiple payment terminal records exist, one payment terminal record may be the master record, while others records synchronize with the master record. In situations where a centralized database is used, master records for payment terminals may be stored on the centralized database.

Whether operating alone or as part of a distributed payment processing center, the computing device 110 may handle enrollments and transactions received from payment terminals in a variety of ways. In some implementations, the computing device sets a payment terminal's state, which can be used to determine how transactions are handled. For example, a payment terminal may be pre-enrolled, which uses a POS identifier to limit enrollment to terminals using the POS identifier and for which a temporary terminal identifier is provided for storing in the authentication cache; the temporary terminal identifier may be overwritten by the actual terminal identifier upon receipt of an enrollment message from the payment terminal associated with the POS identifier. As another example, a payment terminal may be in an enrolled state, which indicates that an enrollment transaction was successfully processed, e.g., using methods described above. A payment terminal may also be in a verified state in situations where a host device verifies that its authentication cache is updated, e.g., by querying a master record for the payment terminal. In situations where a payment terminal is to be revoked, the state of the payment terminal in the authentication cache may be set to revoked, e.g., indicating that the terminal is no longer enrolled.

In some implementations, the computing device 110 may selectively handle transactions and authentication based on the state of the payment terminal. For example, a host device may only allow a transaction to proceed if it has been verified. A host device may allow transactions to proceed only if a terminal has been enrolled, but not necessarily verified. As another example, a host device may always permit transactions without regard to enrollment or verification. The selective handling may be based on a configuration of the host device, e.g., the host device may be placed into various configurations by an administrator or in response to various conditions, and the configuration may dictate how the host device handles payment terminal transactions.

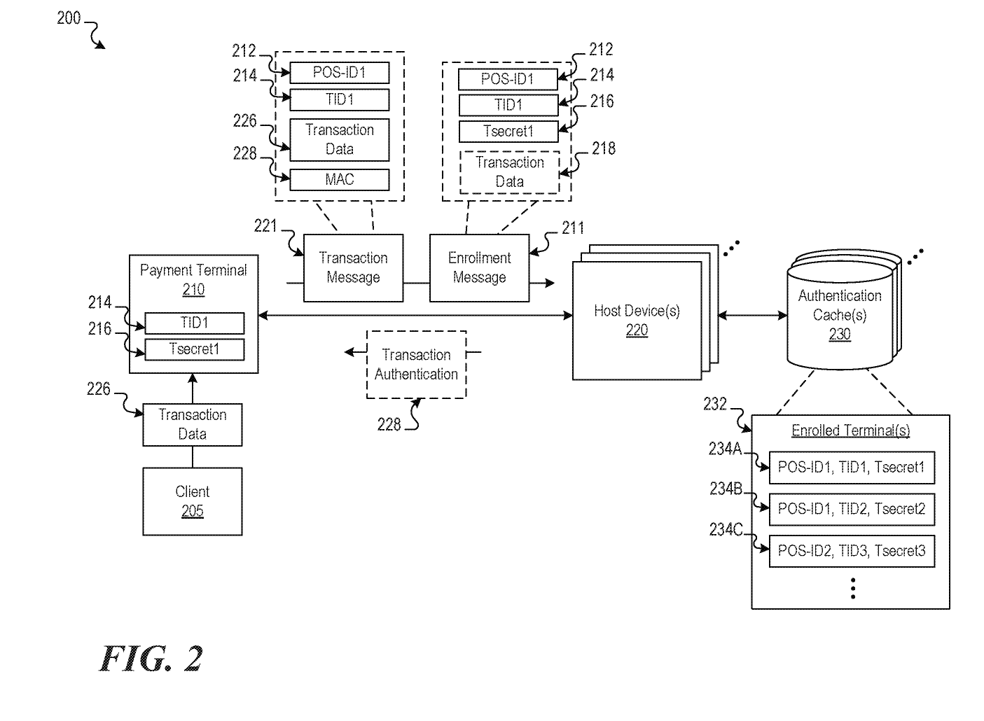

In some implementations, the computing device 110 may selectively determine the manner in which a master payment terminal record is queried and/or updated. For example, a host device may be set to a strict authentication mode, where a master payment terminal record much be queried to ensure it is updated before authentication is permitted. A host device may also use a less strict authentication mode that allows authentication without querying master payment terminal records. Other modes and configurations may be used for host devices for determining how to process transactions based on payment terminal state and/or master payment terminal records. Further examples and details regarding payment terminal authentication are described with respect to FIGS. 2-4 below.

FIG. 2 is a data flow 200 depicting payment terminal authentication. The data flow depicts a payment terminal 210 interacting with one or more host devices 220. Each of the payment terminal 210 and host devices 220 may be a computing device with a processor and computer readable storage medium, e.g., similar to the computing device 110 of FIG. 1. By way of example, the payment terminal 210 may be a retail transaction terminal that accepts debit, credit, and mobile device payments, and the host devices 220 may be payment processing server computers.

The payment terminal 210 obtains a terminal identifier, e.g., TID 214. In some implementations, the terminal identifier is obtained from particular hardware and/or software, e.g., the terminal identifier may be a MAC address associated with the payment terminal 210 or a serial number associated with a processor of the payment terminal 210. In some implementations, the terminal identifier may be obtained from a random or pseudo-random string generator. The terminal identifier is designed to identify a particular payment terminal, and may be unique among other terminal identifiers.

The payment terminal 210 also generates a terminal secret, e.g., Tsecret 216. In some implementations, the terminal secret may be pseudo-randomly generated, e.g., using a random or pseudo-random string generator. The terminal secret is designed to be some value known only to the payment terminal 210 and those entities to which the payment terminal 210 provides the secret.

To enroll with the host device(s) 220, the payment terminal 210 sends an enrollment message 211 to a host device 220. In the example data flow 200, the enrollment message 211 includes a POS identifier, e.g., POS-ID1 212, the terminal identifier, TID1 214, and the terminal secret, Tsecret1 216. The enrollment message 211 may, in some implementations, also include transaction data 218, e.g., in situations where a transaction is to be processed with the enrollment. TID1 214 and Tsecret1 216 may be encrypted prior to being transmitted to the host device 220. For example, using identity-based encryption, the payment terminal 210 may generate a public key for the host device 220 and use the public key to encrypt the TID1 214 and Tsecret1 216. In some implementations, the POS-ID1 212 included in the enrollment message 211 may be added to the message 211 by a POS device which, while not shown in the example data flow 200, may be a device that facilitates communications between the payment terminal 210 and host device 220.

The host device 220 receives the enrollment message 211 and obtains, from the enrollment message 211, the terminal identifier, TID1 214, and the terminal secret, Tsecret1 216. For example, in a situation where the TID1 214 and Tsecret1 216 were encrypted using the host device's public key, the host device 220 may obtain its private key and use the private key to decrypt the encrypted TID1 214 and Tsecret1 216.

To enroll the payment terminal 210, the host device 220 records, in its authentication cache 230, the terminal identifier, the terminal secret, and the POS identifier associated with the payment terminal 210. In the example data flow 200, the host device 220 stores, in the authentication cache 230, a triple 234A that includes POS-ID1, TID1, and Tsecret1. The authentication cache 230 may include other triples for other enrolled payment terminals, such as triples 234B and 234C. In implementations where the enrollment message 211 includes transaction data 218, the host device 220 may process the transaction data 218. Transaction data processing is described in further detail below.

In the example data flow 200, the payment terminal 210 receives transaction data 226 from a client 205. The client 205 may be any entity that provides transaction data 226 to the payment terminal 210. For example, the client 205 may be a person who provides transaction data 226 by swiping a credit or debit card at the payment terminal 205 or a mobile device that uses near field communication (NFC) technology to wirelessly transfer transaction data 226 to the payment terminal 210. A POS device or system, while not depicted in the example data flow 200, may also separately provide a portion of the transaction data 226, such as the amount of a sale, to the payment terminal 210.

After enrollment, the payment terminal 210 processes the transaction associated with the transaction data 226 by transmitting a transaction message 221 to the host device 220. The example transaction message 221 includes a POS identifier, POS-ID1 212, the terminal identifier, TID1 214, the transaction data 226, and a MAC 228. The transaction data 226 provided in the transaction message 221 may be the same as or different from the transaction data 226 provided by the client, e.g., the transaction data 226 in the message may be partially redacted, have information added, and/or be partially encrypted. For example, the transaction data 226 may be encrypted by the payment terminal 210 using a random AES key. In this situation, the random AES key may then also be encrypted, e.g., using the public key of the host device 220, and provided to the host device 220 with the transaction message 221.

The payment terminal 210 generates the MAC 228 included in the transaction message 221 by combining transaction data and the terminal identifier, TID1 214, to create a message. For example, the transaction data 226 may be encrypted using a random AES key, and the resulting string may be concatenated with TID1 214 to create the message. The message may then be provided as input to a MAC generating module, with the terminal secret, Tsecret 216, as the key. The MAC module provides the MAC 228 as output. Using a keyed MAC algorithm ensures that, given the same message as input and the same key, the same MAC will be produced.

The host device 220 receives the transaction message 221 and determines whether the transaction data 226 is authentic, e.g., that it has not been modified and that the payment terminal 210 that provided the transaction message 221 is enrolled/authorized. In the example data flow 200, the host device 220 may obtain, from the authentication cache 230, the triple 234A associated with the terminal identifier, TID1 214, that was provided in the transaction message 221. The host device combines the transaction data 226 that was included in the transaction message 221 with TID1 214 to create a message, which is provided to a MAC generating module that is keyed with Tsecret1 216, which was obtained from the triple 234A recorded in the authentication cache 230. The MAC module outputs a second MAC, and the host device 220 uses the first and second MACs to determine whether the transaction data 226 is authentic. Assuming that the message and key used to create each MAC were the same, the resulting MACs should match. In situations where the first and second MAC match, the host device 220 may determine that the transaction data 226 is authentic and that the terminal 210 has been verified as enrolled. In situations where the first and second MAC do not match, authentication may fail. In some implementations, the host device 220 provides a transaction authentication message 228 to the payment terminal 210 to provide an indication of authentication success or failure.

In implementations where the transaction data 226 is encrypted, the host device 220 may decrypt the transaction data 226. For example, the host device 220 may decrypt, using its private key, a random AES key that was encrypted using the host device's public key. The random AES key may then be used to decrypt the transaction data 226.

In some implementations, POS identifiers may be used to determine the status of a payment terminal and, in some situations, whether a transaction will be authenticated or not. For example, when the POS identifier provided with a transaction message does not match the POS identifier in the authentication cache 230, either the POS identifier has been changed or the payment terminal has a new POS. A host device may be configured to handle a non-matching POS identifier in a variety of ways, e.g., the host device may be configured to process the transaction anyway or decide to reject the transaction.

In some implementations, payment terminals may be re-enrolled, e.g., when changing the POS at which the payment terminals operate and/or when being re-deployed in a separate system. In some implementations, the payment terminal 210 may, after enrollment, send another enrollment message. The new enrollment message may a new terminal identifier and/or a new terminal secret, both of which may have been obtained or re-generated by the payment terminal 210. The host device 220 may be configured to update the authentication cache 230 in response to obtaining the new enrollment message. For example, the old enrollment triple may be deleted or marked as unauthorized, and a new triple with the new terminal identity and/or secret may be recorded.

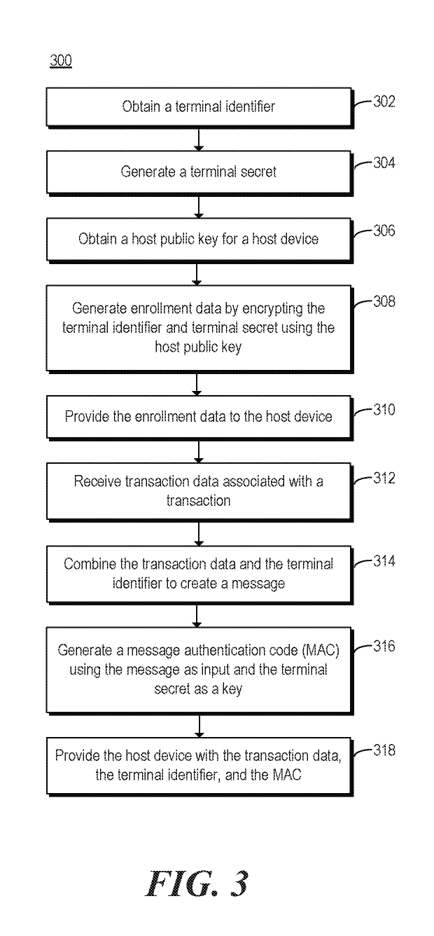

FIG. 3 is a flowchart of an example method 300 for payment terminal authentication. The method 300 may be performed by a computing device, such as a computing device described in FIG. 1 or the payment terminal 210 described in FIG. 2. Other computing devices may also be used to execute method 300. Method 300 may be implemented in the form of executable instructions stored on a machine-readable storage medium, such as the storage medium 130, and/or in the form of electronic circuitry.

A terminal identifier is obtained (302), e.g., by a payment terminal. In some implementations, the terminal identifier may be randomly generated by a payment terminal. In some implementations, the terminal identifier may be obtained from a hardcoded value, e.g., a MAC address or hardware serial number.

A terminal secret is generated (304), e.g., by the payment terminal. In some implementations, the terminal secret is a pseudo-randomly generated string.

A host public key is obtained for a host device (306). For example, in situations where identity based encryption is used, a payment terminal may obtain, from a third party key generator, a public key associated with a particular host device.

Enrollment data is generated by encrypting the terminal identifier and terminal secret using the host public key (308). Enrollment data may be generated, for example, in implementations where payment terminals use an enrollment mode to enroll payment terminals with a host device. Using the host device's public key to encrypt the terminal identifier and terminal secret allows the host device to securely obtain the terminal identifier and terminal secret to enroll the terminal device.

The enrollment data is provided to the host device (310). The enrollment data may be provided in an application message, which may include other data, such as a portion of unencrypted transaction data and/or a POS identifier. In some implementations, a payment terminal may process a transaction during enrollment. In this situation, transaction data may be sent with the enrollment data. Transaction data may be encrypted, e.g., using an AES key that was derived from the payment terminal's terminal secret. The host device would be able to decrypt the transaction data by first obtaining the terminal secret, generating the same AES key using the terminal secret, and using the AES key to decrypt the transaction data.

Transaction data associated with a transaction is received (312). For example, after enrollment, a payment terminal may process transactions in a non-enrollment mode. The transaction data may be provided, for example, by a POS device, a client device, user input, and/or a credit card reader. The transaction data may include a variety of information, such as customer's name, customer's account number, amount of sale, etc.

The transaction data and the terminal identifier are combined to create a message (314). For example, the transaction data and terminal identifier may be combined by concatenating the strings, though other forms of combination may also be used. The transaction data used may be a portion or all of the received transaction data, and it may be encrypted or combined in plain text.

A message authentication code (MAC) is generated using the message as input and the terminal secret as a key (316). For example, a MAC function hash the message using the terminal secret as a key, e.g., so that another device, such as the host device, is able to re-create the same MAC if it keys the same MAC function with the terminal secret and provides the same message as input.

The host device is provided with the transaction data, the terminal identifier, and the MAC (318). The foregoing may be included, for example, in one or multiple application messages to the host device. At least a portion of the data may be encrypted and, in some implementations, the POS identifier may also be included in the data sent to the host device with the transaction data. Transaction data provided to the host device in a non-enrollment mode may, in some implementations, be encrypted with a random AES key that was encrypted using the host's public key, rather than an AES key that was encrypted using the terminal secret as a key.

In some implementations, a payment terminal that implements method 300 may be re-deployed. In this situation, the method may include generating a new terminal identifier, a new terminal secret, and re-enrolling, e.g., in a manner similar to 306-310 above. Terminals may be intentionally placed into enrollment mode for re-deployment or, in some implementations, in response to a compromise or breach of security.

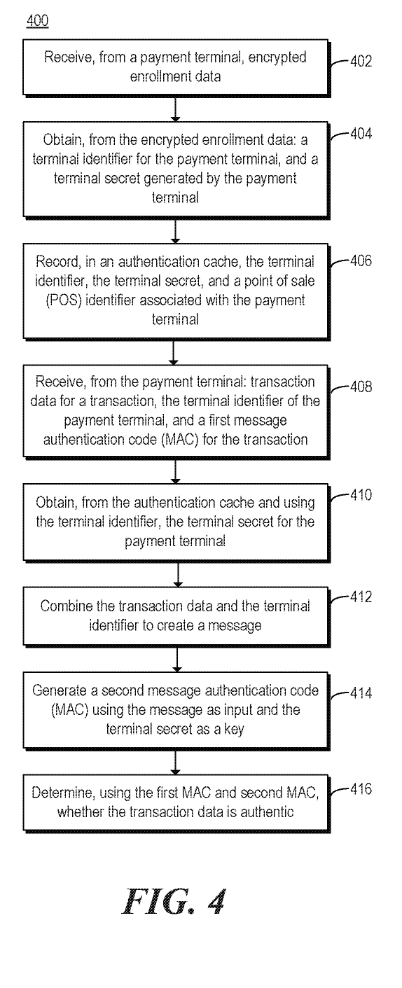

FIG. 4 is a flowchart of an example method 400 for payment terminal authentication at a host device. The method 400 may be performed by a computing device, such as a computing device described in FIG. 1 or a host device 220 described in FIG. 2. Other computing devices may also be used to execute method 400. Method 400 may be implemented in the form of executable instructions stored on a machine-readable storage medium, such as the storage medium 130, and/or in the form of electronic circuitry.

Encrypted enrollment data is received from a payment terminal (402). Encrypted enrollment data may be received, for example, in an application message from a payment terminal that is in an enrollment mode. In some implementations, at least a portion of the enrollment data is encrypted using a public key of the recipient, e.g., a host device's public key.

From the encrypted enrollment data, a terminal identifier for the payment terminal and a terminal secret generated by the payment terminal are obtained (404). In some implementations, the terminal identifier and terminal secret may be encrypted, e.g., using a host device's public key, and they are obtained by the host device using its private key to decrypt.

The terminal identifier, terminal secret, and a point of sale (POS) identifier associated with the payment terminal are recorded in an authentication cache (406). In implementations where the receiving host device operates in a distributed system of multiple host devices and authentication caches, the first triple stored may be a master record, which may be queried and/or copied by other host devices, in a manner designed to ensure that each host device in the distributed system is able to determine that the payment terminal associated with the terminal identifier is enrolled.

From a payment terminal, transaction data for a transaction, the terminal identifier of the payment terminal, and a first message authentication code (MAC) are received (408). The foregoing data may be included in an application message from a terminal that is no longer in enrollment mode. In this situation, the application message may be sent with additional data, such as a POS identifier for a POS associated with the sending payment terminal, and an encrypted key usable for decrypting transaction data.

The terminal secret for the payment terminal is obtained from the authentication cache using the terminal identifier (410). For example, the terminal identifier may be used to look up the corresponding triple in the authentication cache of a host device. In implementations where host devices are part of a distribute system, the host device may be configured to query for a master record associated with the terminal identifier.

The transaction data and the terminal identifier are combined to create a message (412). For example, the encrypted transaction data and the terminal identifier may be combined by concatenation to form the message. The same form of combination used by the payment terminal that created the MAC may be used.

A second MAC is generated using the message as input and the terminal secret as a key (414). For example, the message may be hashed by a hash function that uses the terminal secret as a key. In situations where the hash function input and the key are the same, the hash function is designed to produce the same output, e.g., the same MAC.

Using the first and second MAC, whether the transaction data is authentic is determined (416). For example, a host device may compare the first and second match and determine that the transaction data is authentic in response to the first and second MAC matching. In situations where they do not match, the transaction data may be determined to be non-authentic, e.g., because the transaction data was changed during transmission, or the secret was changed. Results of authentication may be used in a variety of ways, e.g., logging the result, and/or notifying the payment terminal, the corresponding POS, or a system administrator.

While the methods 300 and 400 are described with respect to being performed by a single example computing device, various portions of the methods may be performed by other computing devices. For example, one computing device may be enrolling a payment terminal while another computing device is responsible for authenticating post-enrollment transactions.

The foregoing disclosure describes a number of example implementations for payment terminal authentication. As detailed above, examples provide a mechanism for using soft-state payment terminal credentials to deploy, authenticate, and re-deploy payment terminals in a secure manner.

We claim:

1. A computing device for payment terminal authentication, the computing device comprising:
a hardware processor; and
a data storage device storing instructions that, when executed by the hardware processor, cause the hardware processor to:
receive, from a payment terminal:
transaction data for a transaction,
a terminal identifier of the payment terminal, and
a first message authentication code (MAC) for the transaction;
obtain, from an authentication cache and using the terminal identifier, a terminal secret for the payment terminal;
combine the transaction data and the terminal identifier to create a message;
generate a second message authentication code (MAC) using the message as input and the terminal secret as a key; and
determine, using the first MAC and second MAC, whether the transaction data is authentic.

2. The computing device of claim 1, wherein the instructions further cause the hardware processor to:
receive a first point-of-sale (POS) identifier for a POS associated with the payment terminal;
obtain, from the authentication cache and using the terminal identifier, an authentic POS identifier for the payment terminal; and
determine, using the first POS identifier and authentic POS identifier, whether the payment terminal is enrolled with a POS identified by the authentic POS identifier.

3. The computing device of claim 1, wherein the transaction data is determined to be authentic in response to determining that the first MAC matches the second MAC.

4. The computing device of claim 3, wherein the instructions further cause the hardware processor to:
receive, from the payment terminal and subsequent to determining that the transaction data is authentic, encrypted enrollment data;
obtain, from the encrypted enrollment data, at least one of:
a new terminal identifier that is different from the terminal identifier; or
a new terminal secret that is different from the terminal secret; and
update the authentication cache with at least one of the new terminal identifier or the new terminal secret.

5. The computing device of claim 1, wherein:
the transaction data was encrypted using a random key; and
the hardware processor receives, from the payment terminal, the random key, the random key having been encrypted using a public key associated with the computing device.

6. A method for payment terminal authentication, implemented by a hardware processor, the method comprising:
obtaining a terminal identifier;
generating a terminal secret;
obtaining a host public key for a host device;
generating enrollment data by encrypting the terminal identifier and terminal secret using the host public key;
providing the enrollment data to the host device;
receiving transaction data associated with a transaction;
combining the transaction data and the terminal identifier to create a message;
generating a message authentication code (MAC) using the message as input and the terminal secret as a key; and
providing the host device with the transaction data, the terminal identifier, and the MAC.

7. The method of claim 6, wherein:
the terminal identifier is pseudo-randomly generated;
the terminal secret is pseudo-randomly generated;
combining the transaction data and the terminal identifier comprises concatenating the transaction data and the terminal identifier; and
the MAC is generated by using the terminal secret to key a hash function applied to the message.

8. The method of claim 6, further comprising:
generating an enrollment transaction key using the terminal secret;
encrypting enrollment transaction data using the enrollment transaction key; and
providing the encrypted enrollment transaction data to the host device with the enrollment data.

9. The method of claim 6, further comprising:
generating a pseudo-random key;
encrypting the transaction data using the pseudo-random key;
encrypting the pseudo-random key using a host public key of the host device; and
providing the encrypted pseudo-random key to the host device with the transaction data, the terminal identifier, and the MAC.

10. The method of claim 6, further comprising:
generating a new terminal identifier that is different from the terminal identifier;
generating a new terminal secret that is different from the terminal secret;
generating new enrollment data by encrypting the new terminal identifier and the new terminal secret using the host public key; and
providing the new enrollment data to the host device.

11. A non-transitory machine-readable storage medium encoded with instructions executable by a hardware processor of a computing device for payment terminal authentication, the machine-readable storage medium comprising instructions to cause the hardware processor to:
receive, from a payment terminal, encrypted enrollment data;
obtain, from the encrypted enrollment data:
a terminal identifier for the payment terminal, and
a terminal secret generated by the payment terminal;
record, in an authentication cache, the terminal identifier, the terminal secret, and a point of sale (POS) identifier associated with the payment terminal;
receive, from the payment terminal:
transaction data for a transaction,
the terminal identifier of the payment terminal, and
a first message authentication code (MAC) for the transaction;
obtain, from the authentication cache and using the terminal identifier, the terminal secret for the payment terminal;
combine the transaction data and the terminal identifier to create a message;
generate a second message authentication code (MAC) using the message as input and the terminal secret as a key; and
determine, using the first MAC and second MAC, whether the transaction data is authentic.

12. The storage medium of claim 11, wherein:
the encrypted enrollment data has been encrypted using a public key of the computing device;
the transaction data was encrypted using a random key; and
the transaction data and the terminal identifier were combined by concatenation.

13. The storage medium of claim 11, wherein the transaction data is determined to be non-authentic in response to one of:
the first MAC not matching the second MAC; or
the POS identifier associated with the payment terminal not matching a second POS identifier associated with the transaction.

14. The storage medium of claim 11, wherein:
the transaction is determined to be authentic in response to determining that the first MAC matches the second MAC; and
the instructions further cause the hardware processor to:
receive, from the payment terminal and subsequent to determining that the transaction is authentic, encrypted enrollment data;
obtain, from the encrypted enrollment data, at least one of:
a new terminal identifier that is different from the terminal identifier; or
a new terminal secret that is different from the terminal secret; and
update the authentication cache with at least one of the new terminal identifier or the new terminal secret.

15. The storage medium of claim 11, wherein the instructions further cause the hardware processor to:
receive, with the encrypted enrollment data, encrypted enrollment transaction data;
generate a key for the encrypted enrollment transaction data using the terminal secret; and
decrypting the encrypted enrollment transaction data using the key.
